(19) United States
(12) Patent Application Publication
(10) Pub. No.: US 2020/0307158 A1
(43) Pub. Date: Oct. 1, 2020

(54) Composite Thermal Strap

(71) Applicant: Utah State University Space Dynamics Laboratory, North Logan, UT (US)

(72) Inventors: Matt Sinfield, Logan, UT (US); Matt Felt, Wellsville, UT (US)

(73) Assignee: Utah State University Space Dynamics Laboratory, North Logan, UT (US)

(21) Appl. No.: 16/831,261

(22) Filed: Mar. 26, 2020

Related U.S. Application Data
(60) Provisional application No. 62/824,897, filed on Mar. 27, 2019.

(51) Int. Cl. B32B 9/04; B32B 15/20; B32B 18/00; B32B 15/04

(52) U.S. Cl. CPC B32B 9/041; B32B 15/20; B32B 2250/40; B32B 15/043; B32B 18/00

(57) ABSTRACT

A composite thermal strap includes a pyrolytic graphite stack with multiple pyrolytic graphite sheets and first and second metal foils immediately adjacent and in thermal contact with the top and bottom faces of the pyrolytic graphite stack, together forming a composite stack. The first and second metal foils do not envelop the front and back sides of the pyrolytic graphite stack. A composite thermal strap also includes first and second metal end blocks with inside surfaces connected to and thermally linked to either end of the composite stack. Also disclosed is a particle containment sleeve configured to capture pyrolytic graphite particles or metal particles that may rub off from the composite stack. Also disclosed is a snorkel, configured to pass air from within a volume encapsulated by the particle containment sleeve and the atmosphere.

### RELATED APPLICATIONS

This application claims priority to U.S. Provisional Application 62/824,897, filed Mar. 27, 2019, and titled, “Composite Thermal Strap,” which is hereby incorporated by reference in its entirety.

### TECHNICAL FIELD

The present disclosure relates to thermal straps, more particularly, to novel systems and methods for pyrolytic graphite sheet thermal straps with metal foils.

### BACKGROUND

Thermal straps are used to transfer heat between two structurally decoupled devices. This is done by thermally connecting numerous pyrolytic graphite sheets (PGS) between two or more metal-end blocks. Pyrolytic-graphite sheet thermal straps have improved heat transfer capabilities over traditional metal-foil thermal straps like aluminum or copper. At 300 K, pyrolytic graphite sheet conducts heat 3.3 times better than pure copper and six times better than pure aluminum. Pyrolytic graphite sheet is also much more flexible than aluminum or copper, providing for improved structural decoupling.

Thermal straps are often used on devices, such as spacecraft, that must be low in mass. The mass-specific thermal conductance of PGS is much higher than aluminum (8.6 times) or copper (15.4 times) making PGS an ideal material for thermal straps.

### SUMMARY

Thermal straps in applications such as spacecraft may be subject to high-vibration environments. High-vibration movement may damage or rip fragile PGS sheets used in thermal straps. In addition, PGS sheets may be easily ripped while installing a thermal strap. While metal foils are much less effective at transferring heat and are heavier, applicants of the present disclosure have identified that the robustness of a PGS thermal strap may be improved by adding one or more metal foils as the outer layers of the PGS stack.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1A illustrates a side view of a composite thermal strap;

FIG. 1B illustrates a composite stack of pyrolytic graphite sheets and metal foils;

FIG. 1C illustrates another composite stack of pyrolytic graphite sheets and metal foils;

FIG. 2 illustrates an isometric view of another composite thermal strap;

FIG. 3 illustrates the heat transfer characteristics of a composite thermal strap;

FIG. 4 illustrates a side view of another composite thermal strap;

FIG. 5A and 5B illustrates a side view and an isometric view, respectively, of another composite thermal strap comprising a particle containment sleeve;

FIG. 6A illustrates a side view of another composite thermal strap comprising a particle containment sleeve and snorkels; and

FIGS. 6B and 6C illustrate detail views of portions of FIG. 6A.

### DETAILED DESCRIPTION

The present disclosure covers apparatuses and associated methods for creating a composite thermal strap. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally”, or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

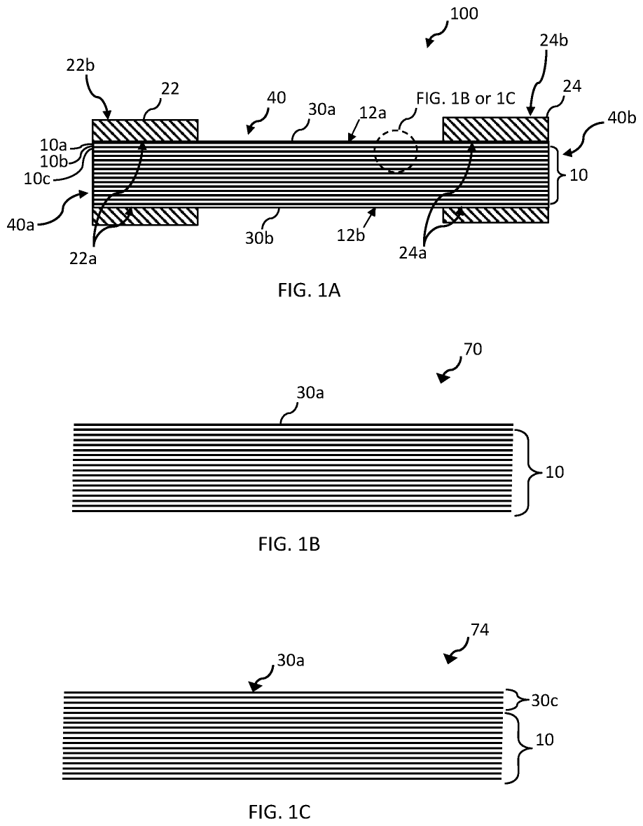

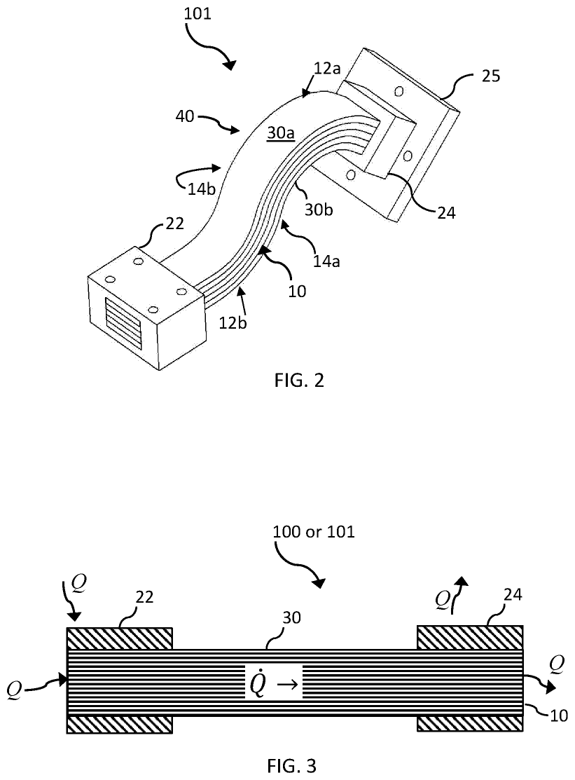

FIG. 1A illustrates a composite thermal strap 100 and FIG. 2 illustrates another composite thermal strap 101. FIGS. 1B and 1C illustrate portions of composite thermal strap 100 or 101. Referring to FIGS. 1A, 1B, and 1C, in embodiments, a composite thermal strap 100 or 101 includes a pyrolytic graphite stack 10 comprising multiple pyrolytic graphite sheets, 10a, 10b, 10c, etc. The pyrolytic graphite stack has top 12a and bottom 12b faces and front 14a and back 14b sides (shown in FIG. 2). In practice, a composite thermal strap may include hundreds of thin pyrolytic graphite sheets. Referring to FIG. 3, the number of sheets in a composite thermal strap is a function of the amount of heat, Q, the composite thermal strap is required to transport. The simplified figures do not depict the numerous pyrolytic graphite sheets typically used in practical applications. For purposes of this disclosure and the illustrations, pyrolytic graphite sheets 10a, 10b, and 10c each may represent tens to hundreds of sheets.

The pyrolytic graphite sheets may be 0.025, 0.07, 0.1, 0.3, 0.5, 1 mm, or thicker. A stack of thinner pyrolytic graphite sheets provide greater heat transfer capability and greater flexibility for a given mass. In many thermal-strap applications, such as in spacecraft, the thermal-strap mass must be minimized to minimize the overall weight of the spacecraft. Additionally, a more flexible thermal strap is much more capable of structurally or vibrationally decoupling two components for which heat is being transferred. However, thinner pyrolytic graphite sheets are more fragile and can tear more readily.

Referring back to FIGS. 1A, 1B, and 1C, the composite thermal strap 100 or 101 also includes first 30a and second 30b metal foils. The first metal foil 30a is immediately adjacent and in thermal contact with the pyrolytic graphite stack top face 12a and the second metal foil 30b is immediately adjacent and in thermal contact with the pyrolytic graphite stack bottom face 12b. FIG. 1B illustrates a top portion of composite stack 70 with first metal foil 30a disposed on top of the pyrolytic graphite stack 10.

FIG. 1C illustrates the top portion of an alternative composite stack 74. In this embodiment, there are multiple metal foils 30a comprising a metal foil stack 30c. The metal foil stack 30c may have as few as two metal foils 30a (or 30b if disposed on the bottom 12b of the pyrolytic graphite stack 10), or may have as many as a few dozen metal foils 30a. Generally, additional metal foils may increase robustness of the composite thermal strap 100 or 101 but may also reduce its heat transfer and flexibility effectiveness.

In embodiments, the metal foils (such as 30a and 30b) are generally the same size as the pyrolytic graphite sheets 10a, 10b, 10c, etc., in pyrolytic graphite stack 10. In embodiments, the first 30a and second 30b metal foils do not envelop the front 14a and back 14b sides of the pyrolytic graphite stack 10. The pyrolytic graphite stack 10 and the first 30a and second 30b metal foils form a composite stack 40 having proximal 40a and distal 40b ends, the composite stack 40 is arranged in order of: the first metal foil 30a, the pyrolytic graphite stack 10, and the second metal foil 30b.

The metal foils 30a and 30b are typically aluminum or copper. In embodiments, the metal foils may also vary in thickness from approximately 0.025 to 1 mm, or thicker. Like the pyrolytic graphite sheets, thinner metal foils provide greater flexibility for a given mass but thinner foils are also more fragile.

Composite thermal straps 100 or 101 also include first 22 and second 24 metal end blocks. Both the first 22 and the second 24 metal end blocks have inside surfaces 22a and 24a, respectively, and outside surfaces 22b and 24b, respectively. The first metal end block inside surface 22a is thermally linked and direct contact to the composite stack proximal end 40a and the second metal end block inside surface 24a is thermally linked and in direct contact to the composite stack distal end 40b. The metal end blocks 22 and 24 may be thermally linked and in direct contact to the composite stack 40 by swaging the metal end blocks 22 and 24 (or metal end block inside surfaces 22a and 24a) around the composite stack 40.

The metal end blocks 22 and 24 may be made of any suitable metal such as aluminum, copper, or other thermally conductive metal suitable for transferring heat, Q, into or out of the composite thermal stack 40. In addition to the metal end blocks 22 and 24, another heat-transfer coupling device 25 (shown in FIG. 2) may be attached to either metal end block 22 or 24. In embodiments, the heat-transfer coupling device 25 may be in direct thermal contact with the pyrolytic graphite stack 10.

FIG. 3 illustrates the heat transfer, Q, through a composite thermal strap 100 or 101. In embodiments, heat, Q, enters metal end block 22 through conduction, radiation, or, if not in a vacuum environment, convection. Heat, Q, may also enter directly into the pyrolytic graphite stack 10 directly through similar means. From the metal end block 22, heat flux, Q(dot), flows through the pyrolytic graphite stack 10 to the second metal end block 24. From second metal end block 24, heat, Q, flows out of the composite thermal strap 100 or 101 through conduction, radiation, or convection (if not in a vacuum environment). Heat, Q, may also flow directly out of the pyrolytic graphite stack 10 by similar means.

In the illustrated embodiments, metal foils 30a and 30b are positioned between the pyrolytic graphite stack 10 and the metal end blocks 22 and 24. As noted in the background section, at 300 K, pyrolytic graphite conducts heat 3.3 times better than pure copper and six times better than pure aluminum. Pyrolytic graphite is also much more flexible than aluminum or copper, providing for improved structural or vibrational decoupling. Thus, adding metal foils 30a and 30b to a composite thermal strap 100 or 101 can decrease the thermal conductivity performance and flexibility of a thermal strap. However, metal foils 30a and 30b added to the top 12a and bottom 12b of the pyrolytic graphite stack 10 are thought to increase the robustness of the composite thermal strap 100 or 101 so as to prevent individual pyrolytic graphite sheets from tearing or ripping during installation or use of the composite thermal strap 100 or 101.

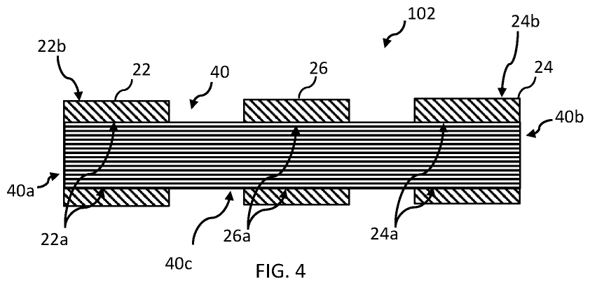

FIG. 4 illustrates another composite thermal strap 102. Composite thermal strap 102 includes another metal end block 26 disposed somewhere between metal end blocks 22 and 24. In embodiments, metal end block 26 also has inside surfaces 26a that is thermally linked and direct contact to the composite stack middle portion 40c. In embodiments, metal end block 26 may comprise two or more additional metal end blocks, each with inside surfaces thermally linked and in direct contact to the composite stack middle portion 40c.

FIG. 4 illustrates the composite stack 40 as a contiguous stack of metal foils and pyrolytic graphite sheets. In embodiments, the composite stack 40 may not be contiguous, but may instead comprise multiple sections of metal foils and pyrolytic graphite sheets. A discontinuous composite stack 40 may be easier to manufacture or may allow for a longer composite thermal strap.

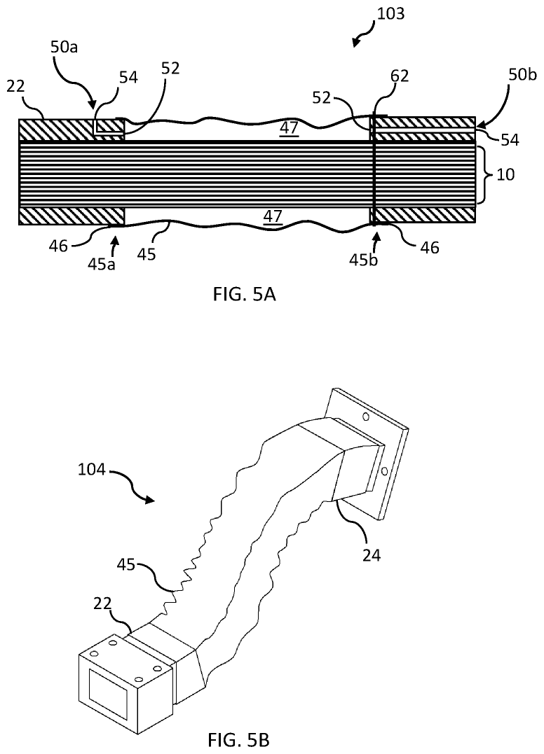

FIGS. 5A and 5B illustrate composite thermal straps 103 and 104. Composite thermal straps 103 and 104 comprise all same features as composite thermal strap 100. In addition, composite thermal straps 103 and 104 comprise a particle containment sleeve 45. The particle containment sleeve 45 encapsulates the composite stack 40, forming a volume 47 encapsulated by the particle containment sleeve 45. Particle containment sleeve 45 is configured to capture pyrolytic graphite or other particles (not shown) that may rub off from any of the multiple pyrolytic graphite sheets 10a, 10b, 10c, etc. or metal foils (such as metal foils 30a or 30b). Particles from the pyrolytic graphite sheets 10a, 10b, 10c, etc. or metal foils 30a or 30b might otherwise escape out into the clean environment of a spacecraft containing a composite thermal strap. The particle containment sleeve may be made from a polyimide sheet (e.g, Kapton), biaxially-oriented polyethylene terephthalate (e.g., Mylar), plastic, or another material suitable for vacuum or space environments.

In embodiments, the particle containment sleeve 45 comprises a particle containment sleeve proximal end 45a and a particle containment sleeve distal end 45b. Particle containment sleeve proximal end 45a attaches to and forms a particle containment connection 46 to the first metal end block outside surface 22b (shown in FIG. 1A) and particle containment sleeve distal end 45b attaches to and forms a particle containment connection 46 to the second metal end block outside surface 24b (also shown in FIG. 1A).

For purposes of this disclosure, a particle containment connection 46 may be a connection between the particle containment sleeve 45 and a metal end block (22, 24, or 26) such that pyrolytic graphite particles from the multiple pyrolytic graphite sheets 10a, 10b, 10c, etc., or metal particles from metal foils 30a or 30b may not easily escape through the particle containment connection 46. In embodiments, the particle containment connection 46 may be an air-tight connection.

The particle containment connection 46 may be formed by bonding the proximal 45a and distal ends 45 of the particle containment sleeve to the outside surface (22b or 24b) of their respective metal end blocks 22 and 24. In embodiments, the adhesive may be Arathane 5753 A/B, produced by Krayden, Inc.

In another embodiment, the particle containment connection 46 may be formed by wrapping a wire or lacing tape 62 around the outside of the particle containment sleeve 45, or the particle containment sleeve proximal 45a and distal 45b ends, and the outside surface 22b or 24b of the metal end blocks 22 or 24. In FIG. 5A, the wire or lacing tape 62 is shown wrapped around only the outside surface 24b of metal end block 24.

Configuring the particle containment sleeve 45 such that it is wrapped around the outside surface 22b or 24c (as opposed to the inside surface 22a or 24a) of metal end blocks 22 or 24 provide for easy replacement of the particle containment sleeve 45 should it be damaged in testing or installation. Also, because the particle containment sleeve 45 is not attached to the inside surface 22a or 24a of the metal end blocks 22 or 24, the particle containment sleeve 45, because it is made of Kapton, Mylar, or another plastic, does not interrupt the flow of heat, Q, from the composite thermal stack 40 to the metal end blocks 22, 24, or 26.

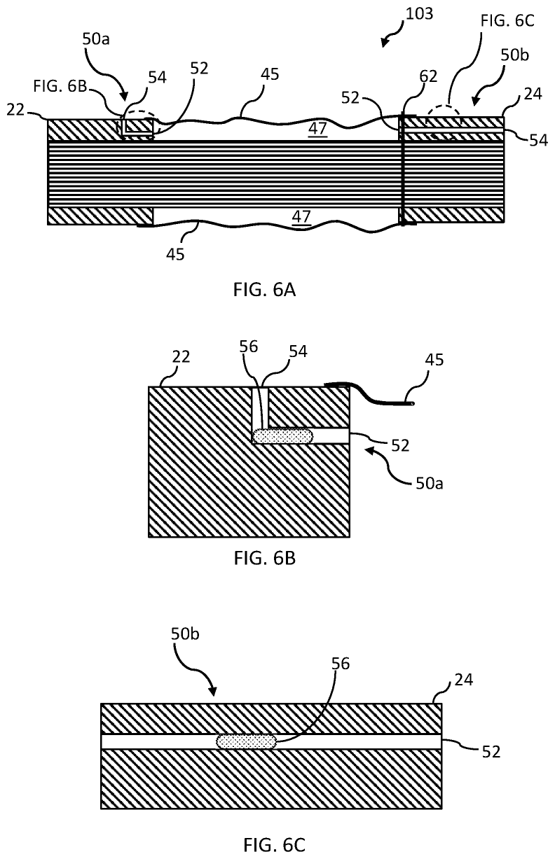

Referring to FIGS. 5A, 6A, 6B, and 6C, in embodiments, the composite thermal straps 103 and 104 also comprise a snorkel 50a or 50b. A snorkel 50a or 50b may be necessary when the composite thermal strap 103 or 104, including particle containment sleeve 45 that forms an air-tight connection, or encapsulated volume 47 (that might be air-tight), with metal end blocks 22, 24, or 26, is assembled under atmospheric conditions but operates in a vacuum, such as the vacuum of space.

FIGS. 5A, 6A, 6B, and 6C illustrate two (of many) possible configurations of a snorkel: 50a embedded in metal end block 22 and 50b embedded in metal end block 24. A snorkel 50a or 50b comprises a snorkel inlet 52 and a snorkel vent 56. A snorkel 50a or 50b is configured to allow air to pass from a volume enclosed by the particle containment sleeve 45 and metal end blocks 22, 24, or 26 to atmosphere, or outside the volume enclosed by the particle containment sleeve 45 and metal end blocks 22, 24, or 26.

In embodiments, a snorkel 50a or 50b also comprises a filter 56. A filter 56 may be a piece of sintered metal that allows air to vent through the snorkel but prevents particles, such as pyrolytic graphite particles (not shown) that may rub off from any of the multiple pyrolytic graphite sheets 10a, 10b, 10c, etc.

In other embodiments, a vent may be installed into the particle containment sleeve to vent air from a volume enclosed by the particle containment sleeve 45 and metal end blocks 22, 24, or 26 to atmosphere.

Disclosed herein is also a method for creating a composite thermal strap 100 or 101. In embodiments, a method for creating a composite thermal strap comprises arranging a stack of multiple pyrolytic graphite films 10, the pyrolytic graphite stack 10 having top 12a and bottom faces 12b and front 14a and back 14b sides. The method further includes providing first 30a and second 30b metal foils and arranging the first metal 30a foil immediately adjacent and in thermal contact with the pyrolytic graphite stack 10 top face 12a but not enveloping the front 14a or back 14b sides of the pyrolytic graphite stack 10. Also, arranging the second metal foil 30b immediately adjacent and in thermal contact with the pyrolytic graphite stack 10 bottom face 12b but not enveloping the front 14a or back 14b sides of the pyrolytic graphite stack 10.

The method further includes arranging the pyrolytic graphite stack 10 and the first 30a and second 30b metal foils to form a composite stack 40 having proximal and distal ends, the composite stack 40 arranged in order of: the first metal foil 30a, the pyrolytic graphite stack 10, the second metal foil 30b. Finally, the method includes thermally linking a first metal end block 22 to the composite stack 40 proximal end and thermally linking a second metal end block 24 to the composite stack 40 distal end such that the composite stack 40 physically separates the first metal end block 22 from the second metal end block 24.

In other embodiments for the method for forming a composite thermal strap 100 or 101, the first 30a and second 30b metal foils are first 30c and second (not labeled) metal foil stacks, each having multiple metal foils.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

We claim:

1. A composite thermal strap, comprising:
a pyrolytic graphite stack comprising multiple pyrolytic graphite sheets, the pyrolytic graphite stack having top and bottom faces and front and back sides;
first and second metal foils;
wherein:
the first metal foil is immediately adjacent and in thermal contact with the pyrolytic graphite stack top face,
the second metal foil is immediately adjacent and in thermal contact with the pyrolytic graphite stack bottom face, and
the first and second metal foils do not envelop the front or back sides of the pyrolytic graphite stack, and
the pyrolytic graphite stack and the first and second metal foils form a composite stack having a proximal end, a distal end, and a middle portion, the composite stack arranged in order of: the first metal foil, the pyrolytic graphite stack, the second metal foil; and
first and second metal end blocks, both the first and the second metal end blocks having an inside surface and an outside surface, the first metal end block inside surface thermally linked and in direct contact to the composite stack proximal end and the second metal end block inside surface thermally linked and in direct contact to the composite stack distal end.

2. The composite thermal strap of claim 1, wherein the first and the second metal foils are first and second metal foil stacks, each of the first and the second metal foil stacks having multiple metal foils.

3. The composite thermal strap of claim 1, further comprising a third metal end block having an inside surface, the third metal end block inside surface thermally linked and in direct contact to the composite stack middle portion.

4. The composite thermal strap of claim 3, wherein the third metal end block comprises two or more metal end blocks, each with inside surfaces thermally linked and in direct contact to the composite stack middle portion.

5. The composite thermal strap of claim 1, further comprising a particle containment sleeve, wherein the particle containment sleeve:
comprises proximal and distal ends, the particle containment sleeve proximal end attaches to and forms a particle containment connection to the first metal end block outside surface and the particle containment sleeve distal end attaches to and forms a particle containment connection to the second metal end block outside surface;
encapsulates the composite stack between the first and second metal end blocks; and
is configured to capture pyrolytic graphite particles that may rub off from any of the multiple pyrolytic graphite sheets or metal particles that may rub off from the first or second metal foils.

6. The composite thermal strap of claim 5, further comprising a snorkel, the snorkel formed from a hole extending through either the first or second metal end block from a volume encapsulated by the particle containment sleeve to an atmospheric vent, the snorkel containing a filter configured to prevent passage of the pyrolytic graphite particles or metal particles as air flows through the snorkel.

7. A method for creating a composite thermal strap, the method comprising:
arranging a stack of multiple pyrolytic graphite sheets, the pyrolytic graphite stack having top and bottom faces and front and back sides;
providing first and second metal foils;
arranging the first metal foil immediately adjacent and in thermal contact with the pyrolytic graphite stack top face but not enveloping the front or back sides of the pyrolytic graphite stack;
arranging the second metal foil immediately adjacent and in thermal contact with the pyrolytic graphite stack bottom face but not enveloping the front or back sides of the pyrolytic graphite stack;
arranging the pyrolytic graphite stack and the first and second metal foils to form a composite stack having a proximal end, a distal end, and a middle portion, the composite stack arranged in order of: the first metal foil, the pyrolytic graphite stack, the second metal foil;
thermally linking an inside surface of a first metal end block to the composite stack proximal end; and
thermally linking an inside surface of a second metal end block to the composite stack distal end; wherein
the composite stack physically separates the first metal end block from the second metal end block.

8. The method for creating a composite thermal strap of claim 7, wherein the first and second metal foils are first and second metal foil stacks, each having multiple metal foils.

9. The method for creating a composite thermal strap of claim 7, further comprising providing a third metal end block having an inside surface, the third metal end block inside surface thermally linked and in direct contact to the middle portion of the composite stack.

10. The method for creating a composite thermal strap of claim 9, wherein the third metal end block comprises two or more metal end blocks, each with inside surfaces thermally linked and in direct contact to the composite stack middle portion.

11. The method for creating a composite thermal strap of claim 7, further comprising providing a particle containment sleeve, wherein the particle containment sleeve:
comprises proximal and distal ends, the proximal end attaches to and forms a particle containment connection to an outside surface of the first metal end block and the distal end attaches to and forms a particle containment connection to an outside surface of the second metal end block;
encapsulates the composite stack between the first and second metal end blocks; and
is configured to capture pyrolytic graphite particles that may rub off from any of the multiple pyrolytic graphite sheets or metal particles that may rub off from the first or second metal foils.

12. The method for creating a composite thermal strap of claim 11, further comprising providing a snorkel, the snorkel formed from a hole extending through either the first or second metal end block from a volume encapsulated by the particle containment sleeve to an atmospheric vent, the snorkel containing a filter configured to prevent passage of the pyrolytic graphite particles or metal particles as air flows through the snorkel.
